(19) United States
(12) Patent Application Publication
(10) Pub. No.: US 2026/0361223 A1
(43) Pub. Date: Nov. 12, 2026

(54) SWITCH MODE POWER SUPPLY ARCHITECTURE

(71) Applicant: SEA SONIC ELECTRONICS CO., LTD., Taipei City (TW)

(72) Inventors: Chien-Tung LAN, Taipei City (TW); Chih-Sheng CHANG, Taipei City (TW); Sheng-Chien CHOU, Taipei City (TW)

(21) Appl. No.: 19/204,752

(22) Filed: May 12, 2025

(51) Int. Cl. H02M 3/335; H02M 1/42; H02M 3/00

(52) U.S. Cl. CPC H02M 3/33507; H02M 1/4241; H02M 3/01

(57) ABSTRACT

A switch mode power supply architecture, including a power factor correction circuit, an LLC resonant conversion circuit and a wide input range buck circuit. The power factor correction circuit is connected to an AC power and adjusts a first output voltage provided to a back-end circuit thereof based on an output power. The LLC resonant conversion circuit serves as a back-end circuit of the power factor correction circuit and receives the first output voltage. The LLC resonant conversion circuit provides a second output voltage to its back-end circuit. The LLC resonant conversion circuit is open-loop controlled. The LLC resonant conversion circuit is maintained to operate at a series resonant frequency point to provide the second output voltage in a full resonant mode. The wide input range buck circuit serves as the back-end circuit of the LLC resonant conversion circuit and receives the second output voltage.

### TECHNICAL FIELD

The present invention relates to a switch mode power supply architecture, and in particular to a switch mode power supply architecture which can prevent waste heat from being concentrated on a specific circuit.

### BACKGROUND ART

The current switch mode power supply architecture is disclosed in patents such as TW201505348A, CN116885952A, and CN110504847A.

The current switch mode power supply architecture mainly includes a power factor correction circuit and a resonant conversion circuit. When the switch mode power supply architecture is implemented, the power loss is mainly distributed in the power factor correction circuit and the resonant conversion circuit. The power factor correction circuit loss mainly occurs in the case of low voltage input and high voltage output. The purpose of the power factor correction circuit maintaining a high voltage output is to meet the output regulation rate requirement of the resonant conversion circuit.

The resonant conversion circuit in the current switch mode power supply architecture is generally implemented with an isolated LLC resonant circuit. The loss of the resonant conversion circuit is mainly caused by the transformer and synchronous rectification. Specifically, the output voltage of the resonant conversion circuit is 12V. Once the back-end load demand increases, the current will increase significantly, and the transformer secondary copper loss and synchronous rectification loss will increase significantly.

As mentioned above, the current switch mode power supply architecture has losses concentrated in certain circuits, and waste heat is also accumulated in the aforementioned circuits, so the current switch mode power supply architecture is generally implemented with an active heat sink (such as a cooling fan) to dissipate heat through the active heat sink, and is difficult to be used in a fanless power supply.

### SUMMARY OF THE INVENTION

An object of the present invention is to solve the problem that the waste heat of the conventional switch mode power supply architecture is concentrated on a power correction circuit and a resonant conversion circuit.

In order to achieve the above-mentioned object, the present invention provides a switch mode power supply architecture connected to an AC power and provided power to at least one load. The switch mode power supply architecture is provided with an output power. The switch mode power supply architecture comprises a power correction circuit, an LLC resonant conversion circuit and a wide input range buck circuit.

The power factor correction circuit is connected to an AC power and adjusts a first output voltage provided to a back-end circuit thereof based on an output power. The LLC resonant conversion circuit serves as a back-end circuit of the power factor correction circuit and receives the first output voltage. The LLC resonant conversion circuit provides a second output voltage to its back-end circuit. The LLC resonant conversion circuit is open-loop controlled. The LLC resonant conversion circuit is maintained to operate at a series resonant frequency point to provide the second output voltage in a full resonant mode. The wide input range buck circuit serves as the back-end circuit of the LLC resonant conversion circuit and receives the second output voltage, and the wide input range buck circuit is connected to the at least one load.

In one example, the power factor correction circuit comprises a light load output mode and a heavy load output mode, the power factor correction circuit operates in the light load output mode and the heavy load output mode based on a result of comparing the output power with a comparison value, a voltage value of the first output voltage will be greater than a peak value of an input voltage when the power factor correction circuit is in the light load output mode, and the power factor correction circuit adjusts the first output voltage based on the output power in the heavy load output mode.

In one example, the switch mode power supply architecture comprises a flyback conversion circuit served as the back-end circuit of the power factor correction circuit and receives the first output voltage, a transformer connected to the flyback conversion circuit, and an auxiliary power output circuit served as the back-end circuit of the transformer and provided a standby power.

In one example, the switch mode power supply architecture comprises a secondary power conversion circuit served as the back-end circuit of the wide input range buck circuit and provided at least one third output voltage.

In one example, the switch mode power supply architecture comprises a first management circuit served as an accessory circuit of the LLC resonant conversion circuit, a second management circuit served as the accessory circuit of the power factor correction circuit, and a signal isolator connected to the first management circuit and the second management circuit; the first management circuit receives a power start signal from the at least one load, the first management circuit and the second management circuit transmit signals through the signal isolator, and the first management circuit provides a power normal signal to the at least one load.

In one example, the switch mode power supply architecture does not comprise cooling fan for providing heat dissipation for at least the LLC resonant conversion circuit and the wide input range buck circuit.

In one example, the first output voltage of the power factor correction circuit ranges from 130V to 420V, and the second output voltage of the LLC resonant conversion circuit ranges from 13V to 60V.

The present invention has the following characteristics compared to the conventional ones through the aforementioned implementation: the switch mode power supply architecture avoids excessive loss in a part of circuits through the aforementioned structure, so that the loss is dispersed in each level of the circuits, thereby achieving the purpose of heat dissipation. In addition, the LLC resonant conversion circuit in the switch mode power supply architecture is open-loop controlled and maintains operation in a full-resonance mode, which simplifies the control of the LLC resonant conversion circuit compared to conventional structures. Furthermore, the switch mode power supply architecture of the present invention can effectively reduce the loss and improve the overall efficiency thereof, which is conducive to the application in high power density power supply.

### BRIEF DESCRIPTION OF THE DRAWINGS

FIG. 1 is a schematic diagram of a first embodiment of a switch mode power supply architecture of the present invention.

FIG. 2 is a schematic diagram of a second embodiment of a switch mode power supply architecture of the present invention.

FIG. 3 is a schematic diagram of a third embodiment of a switch mode power supply architecture of the present invention.

### DETAILED DESCRIPTION OF THE INVENTION

The terms “first” and “second” used in this document are used to distinguish components with the same name and are not used to limit the order of precedence. The detailed description and technical contents of the present invention are as follows with reference to the accompanying drawings.

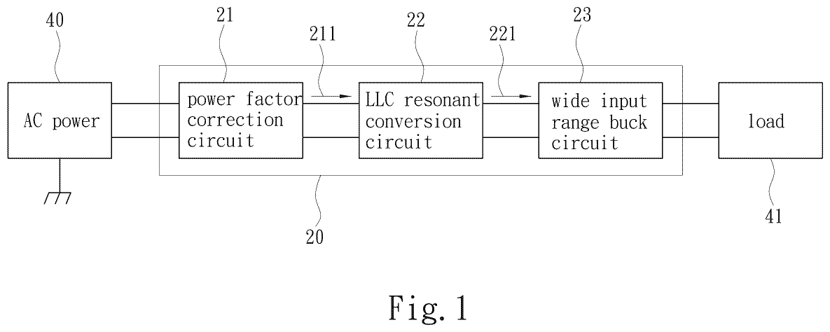

Referring to FIG. 1, the present invention provides a switch mode power supply architecture 20. The switch mode power supply architecture 20 aims to solve the problem that the waste heat generated by the conventional structure during operation is concentrated on some main circuits, which requires a cooling fan to be used. The switch mode power supply architecture 20 of the present invention can be applied to a power supply designed according to an ATX (Advanced Technology Extended) specification, or a fanless power supply. The switch mode power supply architecture 20 is connected to an AC power 40, and supplies power to at least one load 41 after converting the AC power 40. The switch mode power supply architecture 20 has an output power, and includes a power factor correction circuit 21, an LLC resonant conversion circuit 22, and a wide input range buck circuit 23.

The power factor correction circuit 21 is connected to the AC power 40, and the power factor correction circuit 21 serves as a power input terminal of the switch mode power supply architecture 20. The power factor correction circuit 21 adjusts a first output voltage 211 provided to a back-end circuit thereof based on an output power. Specifically, the power factor correction circuit 21 changes its operation according to a current output state of the switch mode power supply architecture 20 to adjust the first output voltage 211 provided to the back-end circuit.

In one example, the power factor correction circuit 21 includes a light load output mode and a heavy load output mode. The power factor correction circuit 21 operates in the light load output mode and the heavy load output mode based on a result of comparing the output power with a comparison value. The comparison value may be based on a rated power of the switch mode power supply architecture 20. For example, the comparison value may be 60% of the rated power. When a current output power of the switch mode power supply architecture 20 is less than 60% of the rated power, the switch mode power supply architecture 20 can be regarded as being in a light-load state, and the power factor correction circuit 21 operates in the light load output mode.

On the contrary, if the current output power of the switch mode power supply architecture 20 is more than or equal to 60% of the rated power, the switch mode power supply architecture 20 can be regarded as being in a heavy-load state, and the power factor correction circuit 21 operates in the heavy load output mode. In the light load output mode, the power factor correction circuit 21 makes the first output voltage 211 greater than a peak value of an input voltage provided by the AC power 40. The aforementioned “greater than” does not mean excessive increase, but only appropriately increases the voltage value of the first output voltage 211. For example, when the power factor correction circuit 21 is in the light load output mode, the voltage value of the first output voltage 211 will be greater than the peak value of the input voltage by 7V to 10V.

This can effectively adjust power factors and improve conversion efficiency, thereby reducing losses and overall heat generation. On the other hand, in the heavy load output mode, the power factor correction circuit 21 adjusts the first output voltage 211 based on the output power. In this mode, the power factor correction circuit 21 requires that the switch mode power supply architecture 20 still has an output power failure hold-up time in the ATX specification.

As mentioned above, in an example, the first output voltage 211 of the power factor correction circuit 21 ranges from 130V to 420V.

Furthermore, the LLC resonant conversion circuit 22 of the present invention serves as a back-end circuit of the power factor correction circuit 21 and receives the first output voltage 211. The LLC resonant conversion circuit 22 provides a second output voltage 221 to its back-end circuit. The LLC resonant conversion circuit 22 of the present invention is open-loop controlled, that is, the LLC resonant conversion circuit 22 does not perform feedback control, that is, the control of the LLC resonant conversion circuit 22 is independent of the load and the first output voltage 211 (that is, the input voltage of the LLC resonant conversion circuit 22). The LLC resonant conversion circuit 22 is maintained to operate at a series resonant frequency point to provide the second output voltage 221 in a full resonant mode.

Furthermore, the LLC resonant conversion circuit 22 of the present invention works in a zero voltage switch mode at full load, and the second output voltage 221 of the LLC resonant conversion circuit 22 is different from the conventional output which is a constant value, and has a wider output range.

In one example, the second output voltage 221 of the LLC resonant conversion circuit 22 ranges from 13V to 60V. Compared with the conventional structure, the LLC resonant conversion circuit 22 of the present invention reduces the output current provided to the back-end circuit thereof, thereby reducing the loss and reducing the heat generation of the LLC resonant conversion circuit 22.

In one example, a turns ratio of the LLC resonant conversion circuit 22 is “7” Furthermore, the turns ratio of the LLC resonant conversion circuit 22 can be adjusted according to the efficiency distribution of an overall architecture.

As mentioned above, the wide input range buck circuit 23 serves as the back-end circuit of the LLC resonant conversion circuit 22. The wide input range buck circuit 23 receives the second output voltage 221. The wide input range buck circuit 23 is connected to the at least one load 41.

The wide input range buck circuit 23 of the present invention may be an interleaved buck converter, a switched capacitor converter, a dual phase 3-level buck converter or a regulated hybrid switched capacitor converter. The wide input range buck circuit 23 supplies 12V power to the at least one load 41. The wide input range buck circuit 23 may combine a plurality of buck circuits according to an output voltage requirement to achieve a requirement of a buck ratio of 2:1, 4:1 or 8:1. An output voltage of the wide input range buck circuit 23 of the present invention can be a DC power of 3.3V to 12V.

The switch mode power supply architecture 20 of the present invention avoids excessive loss in a part of circuits by distributing the loss to each level of the circuits, thereby achieving the purpose of heat dissipation. Furthermore, the switch mode power supply architecture 20 of the present invention does not include a cooling fan for providing heat dissipation for at least the LLC resonant conversion circuit 22 and the wide input range buck circuit 23. In addition, the LLC resonant conversion circuit 22 in the switch mode power supply architecture 20 of the present invention is open-loop controlled and operates in a full-resonance mode, which simplifies the control of the LLC resonant conversion circuit 22 compared to conventional structures. Furthermore, the switch mode power supply architecture 20 of the present invention can effectively reduce the loss and improve the overall efficiency thereof.

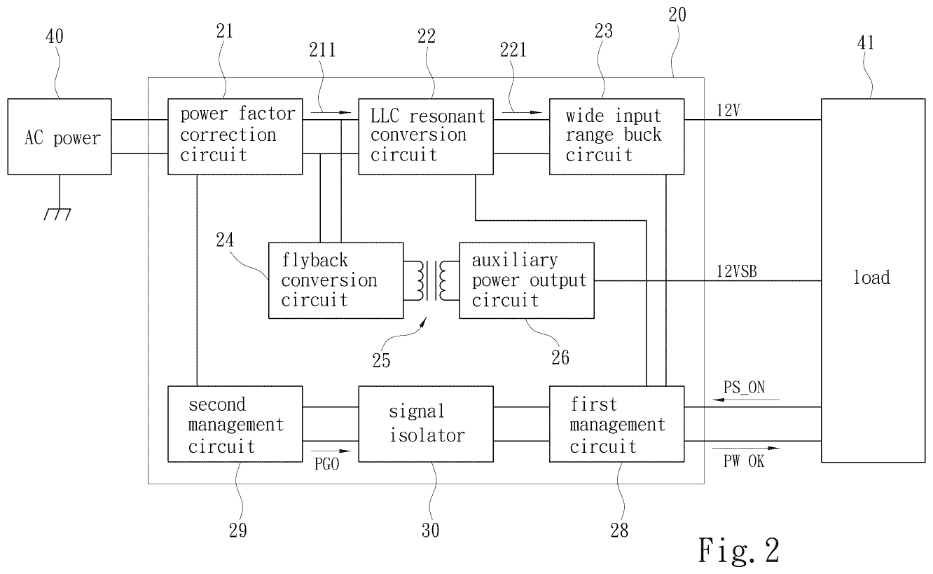

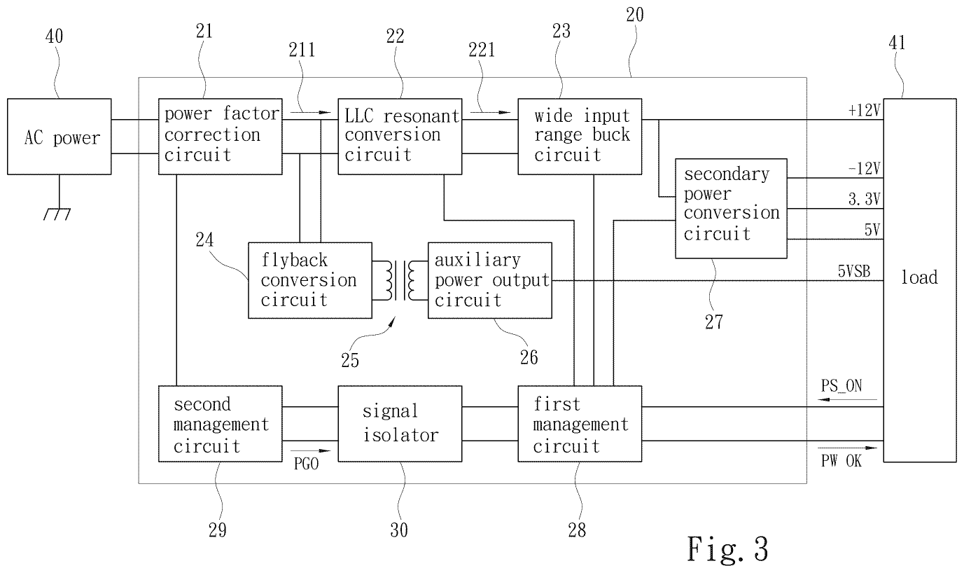

Referring to FIG. 2 and FIG. 3, in an example, the switch mode power supply architecture 20 includes a flyback conversion circuit 24, a transformer 25 and an auxiliary power output circuit 26. The flyback conversion circuit 24 serves as the back-end circuit of the power factor correction circuit 21 and receives the first output voltage 211. The transformer 25 is connected to the flyback conversion circuit 24. The auxiliary power output circuit 26 serves as the back-end circuit of the transformer 25. The auxiliary power output circuit 26 provides a standby power to the flyback conversion circuit 24. The aforementioned standby power is the standby power supply commonly referred to by those skilled in the art. The standby power can be 5V or 12V.

Referring to FIG. 3, in an example, the switch mode power supply architecture 20 includes a secondary power conversion circuit 27. The secondary power conversion circuit 27 serves as the back-end circuit of the wide input range buck circuit 23. The secondary power conversion circuit 27 receives the power output by the wide input range buck circuit 23 and performs power conversion again (for example, bucking). The secondary power conversion circuit 27 provides at least one third output voltage. In this example, the switch mode power supply architecture 20 may provide various voltages required by the ATX specification through the wide input range buck circuit 23 and the secondary power conversion circuit 27. For example, the wide input range buck circuit 23 provides a voltage of +12V, and the secondary power conversion circuit 27 may output voltages of 3.3V and 5V.

In an example, the secondary power conversion circuit 27 can also output a voltage of −12V.

Referring to FIG. 2, in an example, the switch mode power supply architecture 20 includes a first management circuit 28, a second management circuit 29, and a signal isolator 30. The first management circuit 28 serves as an accessory circuit of the LLC resonant conversion circuit 22, and the second management circuit 29 serves as the accessory circuit of the power factor correction circuit 21. The signal isolator 30 connects the first management circuit 28 and the second management circuit 29 so that the first management circuit 28 and the second management circuit 29 can transmit signals therethrough.

When the first management circuit 28 receives a power start signal (PS_ON) from the at least one load 41, the first management circuit 28 sends a status confirmation signal to the second management circuit 29 via the signal isolator 30, and the second management circuit 29 generates a power good (PGO) signal based on a working status of the power factor correction circuit 21. The PGO signal is transmitted to the first management circuit 28 via the signal isolator 30. The first management circuit 28 provides a power normal signal (PW OK) to the at least one load 41. In addition, the first management circuit 28 and the second management circuit 29 are used to start the LLC resonant conversion circuit 22 and the power factor correction circuit 21, respectively. The first management circuit 28 can be implemented by an analog integrated circuit or a digital integrated circuit, and the second management circuit 29 is the same.

1. A switch mode power supply architecture, connected to an AC power and supplying power to at least one load after converting the AC power, the switch mode power supply architecture provided with an output power, and the switch mode power supply architecture comprising:
a power factor correction circuit, connected to the AC power and adjusted a first output voltage provided to a back-end circuit thereof based on the output power;
an LLC resonant conversion circuit, served as a back-end circuit of the power factor correction circuit and received the first output voltage, the LLC resonant conversion circuit providing a second output voltage to its back-end circuit, the LLC resonant conversion circuit being open-loop controlled, and the LLC resonant conversion circuit maintained to operate at a series resonant frequency point to provide the second output voltage in a full resonant mode; and
a wide input range buck circuit, served as the back-end circuit of the LLC resonant conversion circuit and receiving the second output voltage, the wide input range buck circuit connected to the at least one load.

2. The switch mode power supply architecture according to claim 1, wherein the power factor correction circuit comprises a light load output mode and a heavy load output mode, the power factor correction circuit operates in the light load output mode and the heavy load output mode based on a result of comparing the output power with a comparison value, a voltage value of the first output voltage will be greater than a peak value of an input voltage when the power factor correction circuit is in the light load output mode, and the power factor correction circuit adjusts the first output voltage based on the output power in the heavy load output mode.

3. The switch mode power supply architecture according to claim 1, wherein the switch mode power supply architecture comprises a flyback conversion circuit served as the back-end circuit of the power factor correction circuit and receives the first output voltage, a transformer connected to the flyback conversion circuit, and an auxiliary power output circuit served as the back-end circuit of the transformer and provided a standby power.

4. The switch mode power supply architecture according to claim 1, wherein the switch mode power supply architecture comprises a secondary power conversion circuit served as the back-end circuit of the wide input range buck circuit and provided at least one third output voltage.

5. The switch mode power supply architecture according to claim 1, wherein the switch mode power supply architecture comprises a first management circuit served as an accessory circuit of the LLC resonant conversion circuit, a second management circuit served as the accessory circuit of the power factor correction circuit, and a signal isolator connected to the first management circuit and the second management circuit; the first management circuit receives a power start signal from the at least one load, the first management circuit and the second management circuit transmit signals through the signal isolator, and the first management circuit provides a power normal signal to the at least one load.

6. The switch mode power supply architecture according to claim 5, wherein the switch mode power supply architecture does not comprise a cooling fan for providing heat dissipation for at least the LLC resonant conversion circuit and the wide input range buck circuit.

7. The switch mode power supply architecture according to claim 1, wherein the first output voltage of the power factor correction circuit ranges from 130V to 420V, and the second output voltage of the LLC resonant conversion circuit ranges from 13V to 60V.
